(19) United States
(12) Patent Application Publication
(10) Pub. No.: US 2013/0235193 A1
(43) Pub. Date: Sep. 12, 2013

(54) License Plate Image-Pickup Device and Image White Balance Adjustment Method Thereof

(71) Applicants: Wen-Yan Chang, Zhunan Township (TW); Tai-Chang Yang, Kaohsiung City (TW); Chia-Chun Hsieh, Hsinchu (TW); Shan-Lung Chao, Hsinchu (TW); Shih-Yuan Peng, New Taipei City (TW); Hong-Long Chou, Taipei City (TW)

(72) Inventors: Wen-Yan Chang, Zhunan Township (TW); Tai-Chang Yang, Kaohsiung City (TW); Chia-Chun Hsieh, Hsinchu (TW); Shan-Lung Chao, Hsinchu (TW); Shih-Yuan Peng, New Taipei City (TW); Hong-Long Chou, Taipei City (TW)

(73) Assignee: Altek Corporation, Hsinchu (TW)

(21) Appl. No.: 13/445,578

(22) Filed: Apr. 12, 2012

(30) Foreign Application Priority Data
Mar. 9, 2012 (TW) 101107981

(51) Int. Cl. H04N 9/73; H04N 7/18

(52) U.S. Cl. 348/143; 348/223.1; 348/E07.085; 348/E09.052

(57) ABSTRACT

A license plate image-pickup device and an image white balance adjustment method thereof applicable to vehicles. The license plate image-pickup device comprises an image-sensing module, a recognition module, a data base and a processing module. The image-sensing module senses a scene to produce an image.

The recognition module recognizes an object contained in the image and a license plate color feature contained in the object to produce recognition parameter set. The database saves parameter sets of reference objects and reference license plate color features respectively corresponding to the reference objects. The processing module searches the reference objects in the database according to the recognition parameter set, to obtain a corresponding reference license plate color feature, and adjusting the white balance of the image according to the corresponding reference license plate color feature.

### CROSS-REFERENCE TO RELATED APPLICATION

This application claims the benefit of Taiwan Patent Application No. 101107981, filed on Mar. 9, 2012, in the Taiwan Intellectual Property Office, the disclosure of which is incorporated herein in its entirety by reference.

### BACKGROUND OF THE INVENTION

1. Field of the Invention

The present invention relates to a license plate image-pickup device and an image white balance adjustment method, and more particularly to the license plate image-pickup device and the image white balance adjustment method that use a license plate color to perform a white balance adjustment.

2. Description of Related Art

As science and technology advance, and their applications become popular, our life is improved by science and technology to give us tremendous convenience and even assure our safety. For example, automobile equipments of modern motor vehicles generally come with many electronic functions such as driving recording, abnormal car condition recording, automatic braking, reverse radar warning, and car condition communication, etc, wherein driving recorders are the most popular.

Most driving recorders have the real-time imaging function, and users can use a display device to review a recorded situation from a driving recorder. To optimize the recording effect, some of driving recorders are equipped with an image white balance mechanism to provide a better real and actual situation of the recorded image. However, most white balance mechanisms of the conventional driving recorder use the whole image color as reference data to categorize a neutral color and a non-neutral color to perform a white balance adjustment of an image according to the category. Since the driving speed is fast, even two consecutive images have a significant difference. When the neutral color and non-neutral color are categorized, there is no color reference value provided as a reference, so that it is difficult to perform an accurate white balance adjustment of the image.

It is an important subject for related designers or manufacturers to design a license plate image-pickup device and an image white balance adjustment method to achieve the effect of showing images of the actual road condition accurately, so that the inventor of the present invention have designed a license plate image-pickup device and an image white balance adjustment method to overcome the aforementioned drawbacks.

### SUMMARY OF THE INVENTION

In view of the aforementioned problems of the prior art, it is a primary objective of the invention to provide a license plate image-pickup device and an image white balance adjustment method to achieve the effects of capturing an image and performing a white balance adjustment of the image.

To achieve the foregoing objective, the present invention provides a license plate image-pickup device applied in a mobile vehicle, and the license plate image-pickup device comprises: an image-sensing module, a recognition module, a database and a processing module. The image-sensing module senses a scene to produce an image. The recognition module recognizes an object contained in the image and a license plate color feature contained in the object to produce a recognition parameter set. The database stores parameter sets of reference objects and reference license plate color features respectively corresponding to the reference objects. The processing module searches the reference objects in the database according to the recognition parameter set, to obtain a corresponding reference license plate color feature, and adjusts the white balance of the image according to the corresponding reference license plate color feature.

Wherein, the recognition module further recognizes a road surface contained in the image and the processing module determines the road surface according to a reference road surface color feature.

Wherein, the processing module adjusts the white balance of the image according to the corresponding reference license plate color feature and the reference road surface color feature.

Wherein, the license plate image-pickup device further comprises a positioning module for detecting a position of the license plate image-pickup device to produce a position data.

Wherein, the database further comprises parameter sets of reference position data respectively corresponding to the reference objects and the processing module compares the corresponding reference position data in the database according to the position data, and obtains the reference object and license plate color feature in the database according to the reference position data, and the processing module adjust the white balance of the image according to the reference license plate color feature corresponding to the position data.

Wherein, the license plate image-pickup device further comprises a calibrating module provided for a user to set a user parameter, so that the processing module adjusts the white balance of the image according to the user parameter and the corresponding reference license plate color feature.

To achieve the foregoing objective, the present invention further provides an image white balance adjustment method comprising steps of: providing an image-sensing module to sense a scene to produce an image; using a recognition module to recognize an object contained in the image and a license plate color feature contained in the object to produce a recognition parameter set; providing a database to stores parameter sets of reference objects and reference license plate color features respectively corresponding to reference objects; and using a processing module to search the reference objects and reference license plate color features in the database according to the recognition parameter set, and adjust the white balance of the image according to the corresponding reference license plate color feature.

Wherein, the method further comprises steps of: using the recognition module to recognize a road surface contained in the image; using the processing module to determine the road surface according to a reference road surface color feature ; and using the processing module to adjust the white balance of the image according to the corresponding reference license plate color feature and the reference road surface color feature.

Wherein, the method further comprises the step of providing a positioning module to detect a position of the license plate image-pickup device to produce a position data.

Wherein, the database further comprises parameter sets of reference position data respectively corresponding to the reference objects, and the image white balance adjustment method further comprises the steps of: using the processing module to compare the corresponding reference position data in the database according to the position data, and obtaining the corresponding the reference object and the license plate color feature in the database according to the reference position data; and using the processing module to adjust the white balance of the image according to the reference license plate color feature corresponding to the position data.

Wherein, the method further comprises the step of using a calibrating module provided for a user to set a user parameter, such that the processing module adjusts the white balance of the image according to the user parameter and the corresponding reference license plate color feature.

To achieve the foregoing objective, the present invention further provides a license plate image-pickup device applied in a mobile vehicle and comprising: an image-sensing module, for sensing a scene to produce an image; a recognition module, for recognizing an object contained in the image and a license plate color feature contained in the object to produce a recognition parameter set; a database, for storing parameter sets of reference objects and reference license plate color features respectively corresponding to the reference objects; a processing module, for searching the reference objects in the database according to the recognition parameter set, and determining the license plate color feature according to the reference license plate color feature; and a white balance adjustment module, for adjusting the white balance of the image according to the reference license plate color feature.

Wherein, the recognition module further recognizes a road surface contained in the image and the processing module determines a reference road surface according to the road surface color feature.

Wherein, the processing module adjusts the white balance of the image according to the corresponding reference license plate color feature and the reference road surface color feature.

Wherein, the license plate image-pickup device further comprises a positioning module for detecting a position of the license plate image-pickup device to produce a position data.

Wherein, the database further comprises parameter sets of reference position data respectively corresponding to the reference objects, and the processing module compares the corresponding reference position data in the database according to the position data, and obtains the corresponding the reference object and the license plate color feature in the database according to the reference position data, and the processing module adjust the white balance of the image according to the reference license plate color feature corresponding to the position data.

Wherein, the license plate image-pickup device further comprises a calibrating module provided for a user to set a user parameter, and the processing module adjusts the white balance of the image according to the user parameter and the reference license plate color feature.

In summation, the license plate image-pickup device and the image white balance adjustment method of the present invention have one or more of the following advantages:

(1) The license plate image-pickup device and the image white balance adjustment method of the present invention create files of the present existing license plate colors to serve as reference colors of the white balance adjustment to achieve a more accurate white balance adjustment.

(2) The license plate image-pickup device and the image white balance adjustment method of the present invention provide users a way of calibrating related colors for the image processed after the white balance adjustment in order to obtain the users' desired image.

(3) The license plate image-pickup device and the image white balance adjustment method of the present invention further create the present existing license plate color in each country and combine with the global positioning system to achieve the effect of a global application.

### BRIEF DESCRIPTION OF THE DRAWINGS

FIG. 1 is a block diagram of a license plate image-pickup device of the present invention.

FIG. 2 is a first schematic view of a license plate image-pickup device in accordance with a first preferred embodiment of the present invention.

FIG. 3 is a second schematic view of a license plate image-pickup device in accordance with the first preferred embodiment of the present invention.

FIG. 4 is a block diagram of a license plate image-pickup device in accordance with the first preferred embodiment of the present invention.

FIG. 5 is a flow chart of an image white balance adjustment method of the present invention.

FIG. 6 is a schematic view of an image white balance adjustment method in accordance with a preferred embodiment of the present invention.

### DETAILED DESCRIPTION OF THE PREFERRED EMBODIMENTS

The technical contents and characteristics of the present invention will be apparent with the detailed description of a preferred embodiment accompanied with related drawings as follows. For simplicity, same numerals are used in the following preferred embodiment to represent respective same elements.

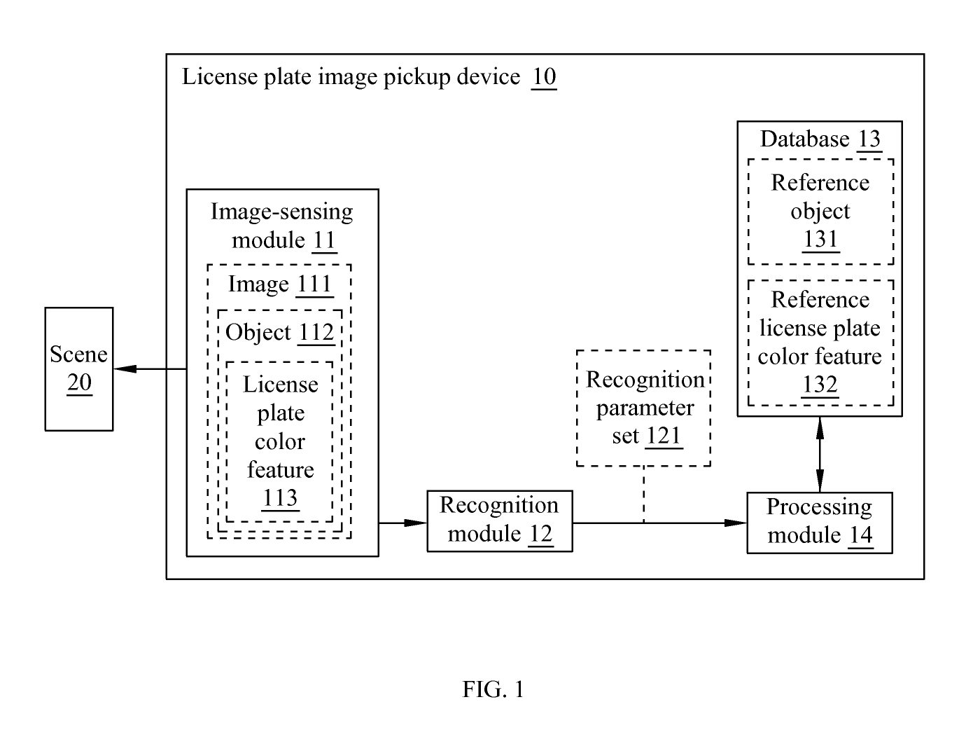

With reference to FIG. 1 for a block diagram of a license plate image-pickup device of the present invention, the license plate image-pickup device 10 comprises: an image-sensing module 11, a recognition module 12, a database 13 and a processing module 14. The image-sensing module 11 senses a scene 20 to produce an image 111. Wherein, the image-sensing module 11 comprises a camera lens, a photo sensor such as a complementary metal oxide semiconductor (CMOS) or charge coupled device (CCD) sensor, an analog/digital circuit, and an image processor. The recognition module 12 recognizes an object 112 contained in the image 111 and a license plate color feature 113 contained in the object 112, to produce a recognition parameter set 121. The database 13 stores parameter sets of reference objects 131 and reference license plate color features 132 respectively corresponding to reference objects 131. Wherein, the database 13 can be a flash Memory. The processing module 14 searches the corresponding reference object 131 and reference license plate color feature 132 in the database 13, according to the recognition parameter set 121, and adjusts the white balance of the image 111 according to the corresponding reference license plate color feature 132. Wherein, the recognition module 12 can be a digital signal processor (DSP), and the processing module 14 can be a microprocessor with the architecture of an advanced RISC machine (ARM) such as the common ARMv7 or ARMv8.

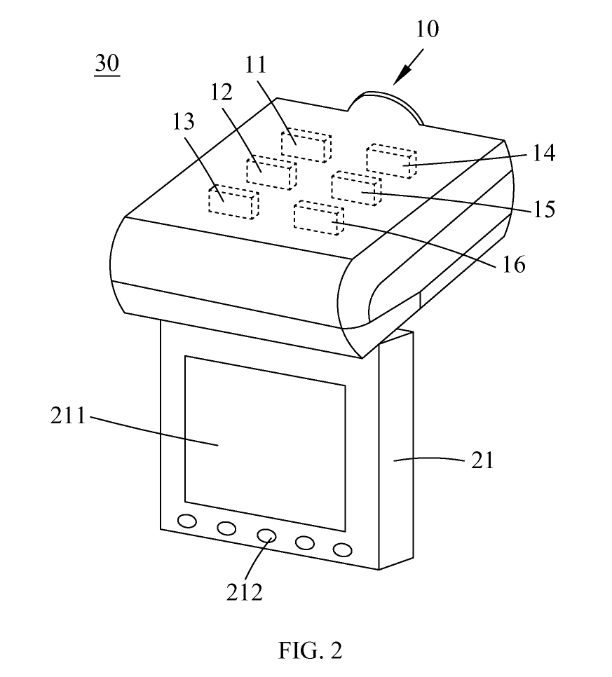

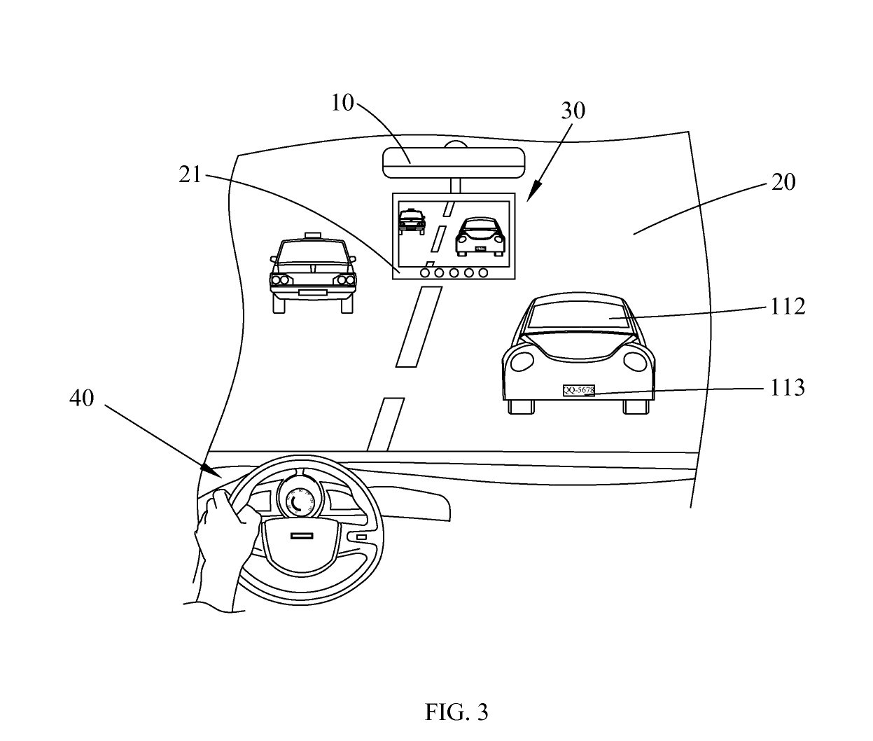

With reference to FIGS. 2 to 4 for a block diagram and first and second schematic views of a license plate image-pickup device in accordance with the first preferred embodiment of the present invention respectively, the license plate image-pickup device 10 is applied in a mobile vehicle 40 and used as a driving recorder 30. In FIGS. 2 and 3, the driving recorder 30 comprises a license plate image-pickup device 10 and a display device 21. The license plate image-pickup device 10 is electrically coupled to the display device 21. The license plate image-pickup device 10 comprises: an image-sensing module 11, a recognition module 12, a database 13, a processing module 14, a positioning module 15 and a calibrating module 16. Wherein, the display device 21 can be integrally formed with the license plate image-pickup device 10 according to the actual requirement, and the setup button 212 can be a physical button or a touch screen. The setup button 212 is coupled to the calibrating module 16. The driving recorder 30 senses a scene 20 through the license plate image-pickup device 10 and the image processed after the white balance adjustment is displayed on the display device 21.

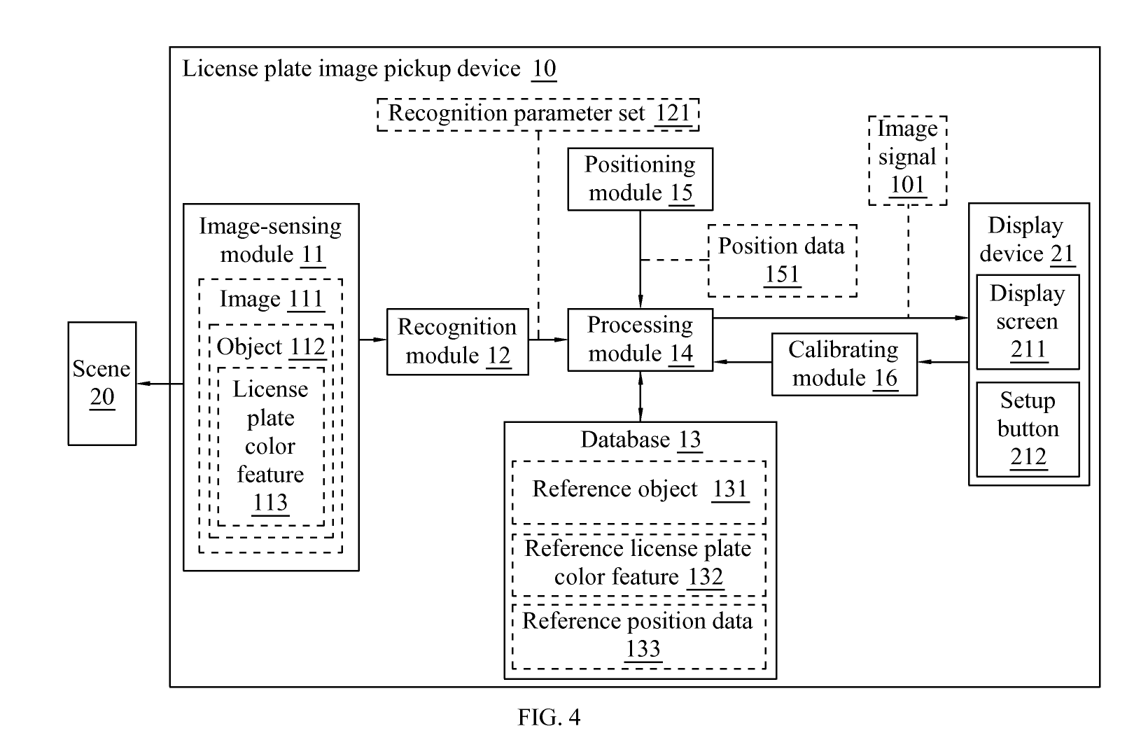

With reference to FIG. 4 together, the image-sensing module 11 senses a scene 20 to produce an image 111. The recognition module 12 recognizes an object 112 and a license plate color feature 113 contained in the object 112 from the image 111 to produce a recognition parameter set 121. The positioning module 15 detects the position of the mobile vehicle 40 to produce position data 151. Wherein, the positioning module 15 can be a global positioning system (GPS). The processing module 14 compares the reference position data 133 in the database 13 according to the position data 151 and searches the corresponding reference object 131 and the corresponding reference license plate color feature 132 in the database 13 according to the recognition parameter set 121. Wherein, the database 13 stores parameter sets of reference objects 131, parameter sets of reference license plate color features 132 and parameter sets of reference position data 133, and the reference license plate color feature 132 corresponds to the reference object 131, and the reference object 131 corresponds to the reference position data 133. More specifically, the database 13 stores reference objects corresponding to different country license plate (such as a green license plate for large vehicles in Country A or a white license plate for small vehicles in Country B). The display device 21 comprises a display screen 211 and a plurality of control buttons (setup button 212).

The processing module 14 determines the license plate color feature 113 according to the reference license plate color feature 132, so as to adjust the white balance of the image 111 to produce an image signal 101. To speed up the image processing, a white balance module (not shown in the figure) can be installed, so that the processing module 14 is provided for the function of replacing the license plate color feature 113 only, and the white balance module further to adjust the white balance of the whole image. The display device 21 receives and displays the image signal 101 on the display screen 211. The users can set the image signal 101 in the display screen 211 according to their personal preference through the setup button 212 of the display device 21. More specifically, the setup button 212 is coupled to the calibrating module 16, and the setup button 212 senses a press operation made by the users to produce the corresponding user parameter, and the processing module 14 adjust the color of the image 111 which has been adjusted the white balance according to the user parameter.

In short, the license plate image-pickup device 10 is combined a display device 21 to serve as a driving recorder 30. The license plate image-pickup device 10 senses a road condition (the scene 20) of an image-sensing module 11 to produce an image 111. The recognition module 12 recognizes the car (the object 112), the license plate color (the license plate color feature 113) from the image 111 to produce a recognition parameter set 121 (such as Large Vehicle—Green License Plate). The positioning module 15 detects the current position of the mobile vehicle 40 to produce position data 151 (such as Country A—District B). The processing module 14 searches the corresponding reference object 131, the reference license plate color feature 132 and the reference position data 133 in the database 13 according to the position data 151 (Country A—District B) and the recognition parameter set 121 (Large Vehicle—Green License Plate) and further determines the license plate color feature 113 according to the reference license plate color feature 132 to adjust the white balance of the image 111. In other words, the processing module 14 searches the corresponding reference license plate color (or the reference green color) in the database 13 according to the detected Country A—District B—Large Vehicle—Green License Plate, and determines the originally detected green license plate by the reference license plate color (or the reference green color) to adjust the white balance of the image 111 and display the processed image on the display screen 211. The user can perform a color related calibration (such as a color temperature calibration) of the display screen from the setup button 212.

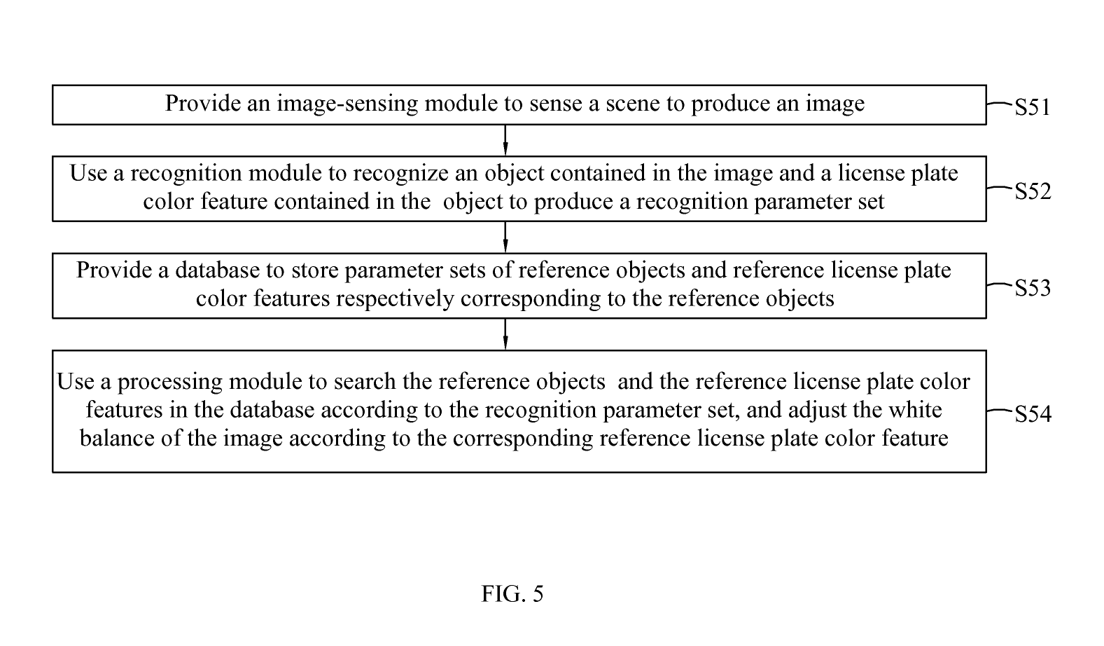

With reference to FIG. 5 for a schematic view of an image white balance adjustment method of the present invention, the image white balance adjustment method can be applied to a license plate image-pickup device 10 and comprises the following steps:

S51: Provide an image-sensing module to sense a scene to produce an image.

S52: Use a recognition module to recognize an object contained in the image and a license plate color feature contained in the object to produce a recognition parameter set.

S53: Provide a database to store parameter sets of reference objects and reference license plate color features respectively corresponding to the reference objects.

S54: Use a processing module to search the reference objects and the reference license plate color features in the database according to the recognition parameter set, and adjust the white balance of the image according to the corresponding reference license plate color feature.

The details and implementation method of the image white balance adjustment method of the present invention have been described in the section of the license plate image-pickup device of the present invention, and thus will not be described again.

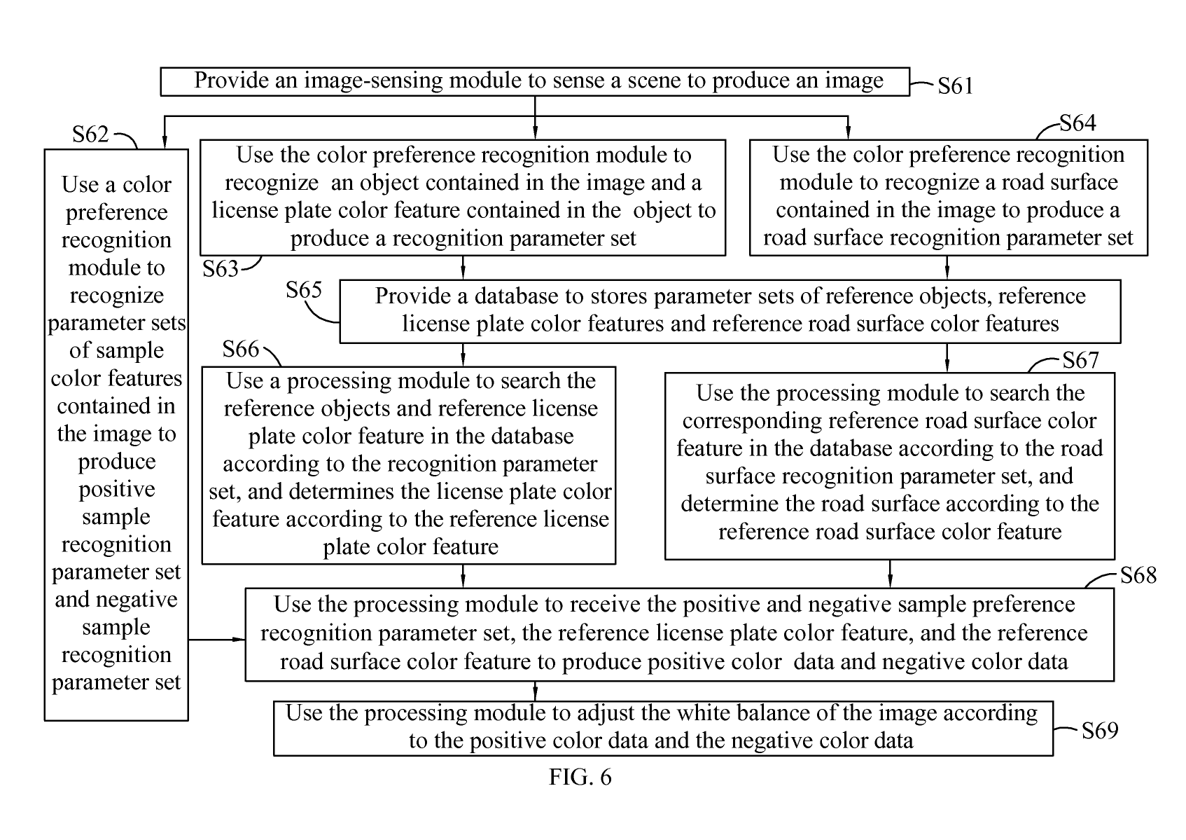

With reference to FIG. 6 for a schematic view of an image white balance adjustment method in accordance with a preferred embodiment of the present invention, the image white balance adjustment can be applied to a license plate image-pickup device 10, and comprises the following steps:

S61: Provide an image-sensing module to sense a scene to produce an image.

S62: Use a color preference recognition module to recognize parameter sets of sample color features contained in the image to produce positive sample recognition parameter set and negative sample recognition parameter set.

S63: Use the color preference recognition module to recognize an object contained in the image and a license plate color feature contained in the object to produce a recognition parameter set.

S64: Use the color preference recognition module to recognize a road surface contained in the image to produce a road surface recognition parameter set.

S65: Provide a database to stores parameter sets of reference objects, reference license plate color features and reference road surface color features.

S66: Use a processing module to search the reference objects and reference license plate color feature in the database according to the recognition parameter set, and determines the license plate color feature according to the reference license plate color feature.

S67: Use the processing module to search the corresponding reference road surface color feature in the database according to the road surface recognition parameter set.

S68: Use the processing module to receive the positive and negative sample preference recognition parameter set, the reference license plate color feature, and the reference road surface color feature to produce positive color (such as neutral color) data and negative color (such as non-neutral color) data.

S69: Use the processing module to adjust the white balance of the image according to the positive color data and the negative color data.

The details of the image white balance adjustment of this preferred embodiment are similar to those described in the section of the license plate image-pickup device of the present invention, and thus will not be repeated.

What is claimed is:

1. A license plate image-pickup device, comprising:
an image-sensing module, for sensing a scene to produce an image;
a recognition module, for recognizing an object contained in the image and a license plate color feature contained in the object to produce a recognition parameter set;
a database, for storing parameter sets of reference objects and reference license plate color features respectively corresponding to the reference objects; and
a processing module, for searching the reference objects in the database according to the recognition parameter set, to obtain a corresponding reference license plate color feature, and adjusting the white balance of the image according to the corresponding reference license plate color feature.

2. The license plate image-pickup device of claim 1, wherein the recognition module further recognizes a road surface contained in the image and the processing module determines the road surface according to a reference road surface color feature.

3. The license plate image-pickup device of claim 2, wherein the processing module adjusts the white balance of the image according to the corresponding reference license plate color feature and the reference road surface color feature.

4. The license plate image-pickup device of claim 1, further comprising a positioning module for detecting a position of the license plate image-pickup device to produce a position data.

5. The license plate image-pickup device of claim 4, wherein the database further comprises parameter sets of reference position data respectively corresponding to the reference objects and the reference license plate color features and the processing module compares the corresponding reference position data in the database according to the position data, and obtains the corresponding reference object and the license plate color feature in the database according to the reference position data, and the processing module adjusts the white balance of the image according to the reference license plate color feature corresponding to the position data.

6. The license plate image-pickup device of claim 1, further comprising a calibrating module provided for a user to set a user parameter, so that the processing module adjusts the white balance of the image according to the user parameter and the corresponding reference license plate color feature.

7. An image white balance adjustment method, comprising the steps of:
providing an image-sensing module to sense a scene to produce an image;
using an recognition module to recognize an object contained in the image and a license plate color feature contained in the object to produce a recognition parameter set;
providing a database to store parameter sets of reference objects and reference license plate color features respectively corresponding to the reference objects; and
using a processing module to search the reference objects and the reference license plate color features in the database according to the recognition parameter set, and adjust the white balance of the image according to the corresponding reference license plate color feature.

8. The image white balance adjustment method of claim 7, further comprising the steps of:
using the recognition module to recognize a road surface contained in the image;
using the processing module to determine the road surface according to a reference road surface color feature; and
using the processing module to adjust the white balance of the image according to the corresponding reference license plate color feature and the reference road surface color feature.

9. The image white balance adjustment method of claim 7, further comprising the step of:
providing a positioning module to detect a position of the license plate image-pickup device to produce a position data.

10. The image white balance adjustment method of claim 9, wherein the database further comprises parameter sets of reference position data respectively corresponding to the reference objects, and the image white balance adjustment method further comprises the steps of:
using the processing module to compare the corresponding reference position data in the database according to the position data, and obtaining the corresponding the reference object and the license plate color feature in the database according to the reference position data; and
using the processing module adjusts the white balance of the image according to the reference license plate color feature corresponding to the position data.

11. The image white balance adjustment method of claim 7, further comprising the step of:
using a calibrating module provided for a user to set a user parameter, such that the processing module adjusts the white balance of the image according to the user parameter and the corresponding reference license plate color feature.

12. A license plate image-pickup device, comprising:
an image-sensing module, for sensing a scene to produce an image;
a recognition module, for recognizing an object contained in the image and a license plate color feature contained in the object to produce a recognition parameter set;
a database, for storing parameter sets of reference objects and reference license plate color features respectively corresponding to the reference objects;
a processing module, for searching the reference objects in the database according to the recognition parameter set, and determining the license plate color feature according to the reference license plate color feature; and
a white balance adjustment module, for adjusting the white balance of the image according to the reference license plate color feature.

13. The license plate image-pickup device of claim 12, wherein the recognition module further recognizes a road surface contained in the image and the processing module determines the road surface according to a reference road surface color feature.

14. The license plate image-pickup device of claim 13, wherein the processing module adjusts the white balance of the image according to the corresponding reference license plate color feature and the reference road surface color feature.

15. The license plate image-pickup device of claim 12, further comprising a positioning module for detecting a position of the license plate image-pickup device to produce a position data.

16. The license plate image-pickup device of claim 15, wherein the database further comprises parameter sets of reference position data respectively corresponding to the reference objects, and the processing module compares the corresponding reference position data in the database according to the position data, and obtains the corresponding the reference object and the license plate color feature in the database according to the reference position data, and the processing module adjusts the white balance of the image according to the reference license plate color feature corresponding to the position data.

17. The license plate image-pickup device of claim 12, further comprising a calibrating module provided for a user to set a user parameter, and the processing module adjusts the white balance of the image according to the user parameter and the reference license plate color feature.
